(19) United States
(12) Patent Application Publication
(10) Pub. No.: US 2016/0092041 A1
(43) Pub. Date: Mar. 31, 2016

(54) SYSTEM AND METHOD TO FACILITATE MATERIAL SELECTION FOR A THREE DIMENSIONAL PRINTING OBJECT

(71) Applicant: MadeSolid, Inc., Emeryville, CA (US)

(72) Inventor: Lance Robert Pickens, Emeryville, CA (US)

(21) Appl. No.: 14/501,021

(22) Filed: Sep. 29, 2014

(51) Int. Cl. G06F 3/0482; G06F 3/0484; B29C 67/00; G06F 3/0481

(52) U.S. Cl. CPC G06F 3/0482; G06F 3/04815; G06F 3/04845; B29C 67/0088

(57) ABSTRACT

The present disclosure relates to a system configured to facilitate material selection for a physical three dimensional object to be manufactured by additive manufacturing. In some implementations, the system may comprise one or more of a processor, a user interface, external resources, electronic storage, and/or other components. The system may be configured such that users may upload an electronic three-dimensional representation of the object that is to be manufactured, receive specified material properties for the (eventually) manufactured object from the user, present the user with a virtual model of the object, facilitate interaction with the virtual model of the object to simulate real world use of the object, and determine one or more materials for use during manufacturing of the physical object.

### FIELD

This disclosure relates to a system and method for facilitating material selection for a physical three dimensional object to be manufactured by additive manufacturing.

### BACKGROUND

Additive manufacturing is well known. Additive manufacturing is known to include a layer by layer three dimensional object formation process wherein exposure to ultraviolet (UV) light cures (solidifies) a polymer resin and adheres the cured polymer resin to a previously solidified layer below. Typically, users select a material for additive manufacturing from one or more predetermined materials made available to the user (e.g., via a physical and/or electronic catalog of materials) by a supplier.

### SUMMARY

One aspect of the disclosure relates to a system configured to facilitate material selection for a physical three dimensional object to be manufactured by additive manufacturing. In some implementations, the system may comprise one or more of a processor, a user interface, external resources, electronic storage, and/or other components. The processor may be configured to provide information processing capabilities in the system. The processor may be configured to execute computer program components. The computer program components may be configured to enable an expert and/or user to interface with the system and/or provide other functionality attributed herein to the system. The computer program components may include an object component, a material property component, a model generation component, a physical material component, and/or other components.

The object component may be configured to obtain electronic information that represents the object to be manufactured by additive manufacturing. In some implementations, the obtained electronic information that represents the object includes dimensions of the object, and/or other information. In some implementations, the object component may be configured to electronically convert (if necessary) the information that represents the object into an electronic format which the system may display and/or use to simulate physical manipulation of the object via the user interface.

The material property component may be configured to facilitate user entry and/or selection of specified values for one or more material properties of the object from a user via the user interface. Facilitating user entry and/or selection of specified values for one or more material properties of the object from a user via the user interface may include effectuating presentation of a graphical user interface to a user via the user interface. The graphical user interface may include one or more views configured to facilitate entry and/or selection of the specified values for the one or more material properties of the object. In some implementations, the material property component may be configured such that the material properties have selectable ranges of values. In some implementations, the selectable ranges of values of the material properties may correspond to ranges of possible values for material properties of predetermined physical real world manufacturing materials used to manufacture the object. In some implementations, the material property component may be configured to determine a selectable range of values based on a user's previous entry and/or selection of a value for a different material property. In some implementations, the material property component may be configured to, responsive to receiving an indication from the user that a specified value for a material property is outside the determined range of selectable values for that material property, recommend changes to values previously entered and/or selected by the user for other material properties.

The model generation component may be configured to generate an electronic three dimensional model of the object based on the obtained information, the specified values for the one or more material properties, information stored in electronic storage, information from external resources, and/or other information. In some implementations, the model generation component may be configured to cause the user interface to display the generated model via one or more views of the graphical user interface. The model generation component may be configured such that the user may virtually manipulate the model via one or more control features provided by the user interface. The model generation component may be configured to cause the user interface to present a result of a virtual manipulation of the model to a user. The presented result of the physical manipulation may include a simulated physical response of the model to the virtual manipulation that reflects the obtained information, the specified values of the one or more material properties, the characteristics of the virtual manipulation, and/or other information. After a user views the result of the virtual manipulation, the user may go back and adjust his or her material property value specifications and the system may cause the user interface to present a result of a (the same and/or different) virtual manipulation of the adjusted model. This process may repeat any number of times until a user settles on an object having desired properties (as indicated by the result of the virtual manipulation presented to the user).

The physical material component may be configured to determine an additive manufacturing material and/or material mixture that corresponds to the entered and/or selected values for the one or more material properties and/or facilitate purchase of the determined material and/or material mixture by the user.

These and other objects, features, and characteristics of the system and/or method disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 is a schematic illustration of a system configured to facilitate material selection for a physical three dimensional object to be manufactured by additive manufacturing.

FIG. 2A illustrates a view of a graphical user interface presented to the user that is configured to facilitate entry and/or selection of specified values for four different material properties.

FIG. 2B illustrates a view of the graphical user interface that includes one or more fields configured to facilitate entry and/or selection of values within ranges of selectable values for the material properties.

FIG. 3 illustrates a view of an electronic three dimensional model generated by a model generation component presented to the user via a display.

FIG. 4 illustrates a method for facilitating material selection for a physical three dimensional object to be manufactured by additive manufacturing.

FIG. 5 illustrates a second method for facilitating material selection for a physical three dimensional object to be manufactured by additive manufacturing.

### DETAILED DESCRIPTION

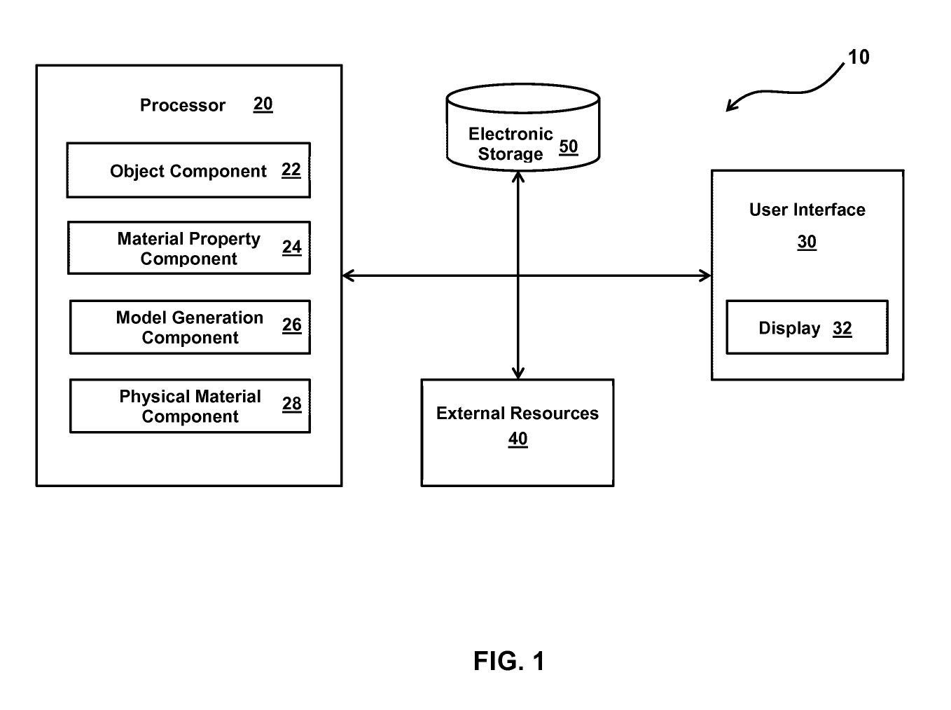

FIG. 1 illustrates a system 10 configured to facilitate material selection for a physical three dimensional object to be manufactured by additive manufacturing. In some implementations, the system may comprise one or more of a processor 20, a user interface 30, external resources 40, electronic storage 50, and/or other components.

System 10 may be configured such that users may upload (and/or system 10 may otherwise obtain) an electronic three-dimensional representation of the object that is to be manufactured. Once the representation of the object is uploaded and/or otherwise obtained, system 10 may be configured to receive specified material properties for the (eventually) manufactured object from the user, present the user with a virtual model of the object, facilitate interaction with the virtual model of the object to simulate real world use of the object (e.g., throwing, dropping, manipulating the object as they would under normal circumstances in everyday life, etc.), and/or provide other functionality with respect to the object. System 10 may be configured such that as the virtual object is electronically subjected to various forces and/or conditions, it may respond based on the obtained representation of the object, the specified material properties, and/or other information.

System 10 may be configured such that users may manipulate properties (e.g., material properties, dimensions, etc.) of the virtual model of the object via user interface 30 and cause the virtual model of the object to take on the properties specified by users. For example, a user may vary the hardness and/or softness (for example) of the simulated object via a scale slider graphic presented via user interface 30, inputting a numerical value that corresponds to hardness and/or softness via user interface 30, and/or by other methods. Once a given material property value is received, system 10 may be configured such that the specified given material property is reflected by the simulated object in response to virtual manipulation by the user.

By way of non-limiting example, system 10 may obtain and simulate an electronic representation of a spring. System 10 may be configured to facilitate user entry and/or selection of specified values for one or more properties of the spring from a user via graphical user interface 30. System 10 may be configured such that in a virtual model of the spring, a weight may be attached to the spring and system 10 may determine an amount of spring deformation to show in the virtual model based on entered and/or received values of material properties of the spring and/or other information. As different material properties are varied by the user, system 10 may be configured to cause the length of the virtual model of the spring to grow and/or contract in response.

Once a user settles on specified material properties for the object that is to be manufactured, system 10 may determine one or more materials for use during manufacturing of the physical object. In some implementations, system 10 may determine a mixture of materials for use during manufacturing. The material(s) used for manufacturing may correspond to the specified material properties. In some implementations, system 10 may facilitate purchase and/or distribution of this determined material and/or material mixture so that the object may be physically manufactured from the determined material(s).

Processor 20 may be configured to provide information processing capabilities in system 10. Processor 20 may communicate wirelessly with user interface 30, external resources 40, electronic storage 50, and/or other components of system 10. In some implementations, processor 20 may communicate with user interface 30, external resources 40, electronic storage 50, and/or other components of system 10 via wires. In some implementations, processor 20 may be included in the same physical computing device (e.g., a laptop computer, a desktop computer, a smartphone, etc.) as user interface 30, external resources 40, electronic storage 50, and/or other components of system 10. In some implementations, processor 20 may be remotely located (e.g., within a remote server) relative to user interface 30, external resources 40, electronic storage 50, and/or other components of system 10.

Processor 20 may be configured to execute computer program components. The computer program components may be configured to enable an expert and/or user to interface with system 10 and/or provide other functionality attributed herein to user interface 30, external resources 40, electronic storage 50, and/or processor 20. The computer program components may include an object component 22, a material property component 24, a model generation component 26, a physical material component 28, and/or other components.

Object component 22 may be configured to obtain electronic information that represents the object to be manufactured by additive manufacturing. In some implementations, the obtained electronic information that represents the object includes dimensions of the object, tolerances of the dimensions, color and/or texture of various surfaces, material properties per region defined explicitly or algorithmically, and/or other information. In some implementations, object component 22 may be configured to electronically convert (if necessary) the information that represents the object into an electronic format which system 10 may display and/or use to simulate physical manipulation of the object (described below) via user interface 30.

Material property component 24 may be configured to facilitate user entry and/or selection of specified values for one or more material properties of the object from a user via user interface 30. Facilitating user entry and/or selection of specified values for one or more material properties of the object from a user via user interface 30 may include effectuating presentation of a graphical user interface to a user via user interface 30. The graphical user interface may be presented via user interface 30, a computing device associated with an individual user (e.g., a desktop computer, a laptop computer, a tablet computer, a smartphone, etc.), and/or other interfaces, for example. The graphical user interface may be configured to facilitate entry and/or selection of information from a user, display information to the user, and/or function in other ways. The graphical user interface may include one or more views configured to facilitate entry and/or selection of the specified values for the one or more material properties of the object. The one or more material properties may include one or more of elastic modulus, hardness, density, weight, color, refractive index, dielectric properties, tensile strength, glass transition temperature, impact strength, properties related to experiential interaction otherwise referred to as qualia such as scent, taste, feel, visual perception, and/or other material properties. Some properties may be related to how humans perceive an object and/or may have complex interactions with various underlying properties. For example, the warmth of wood versus the cold feel of metal may be related to a constellation of properties.

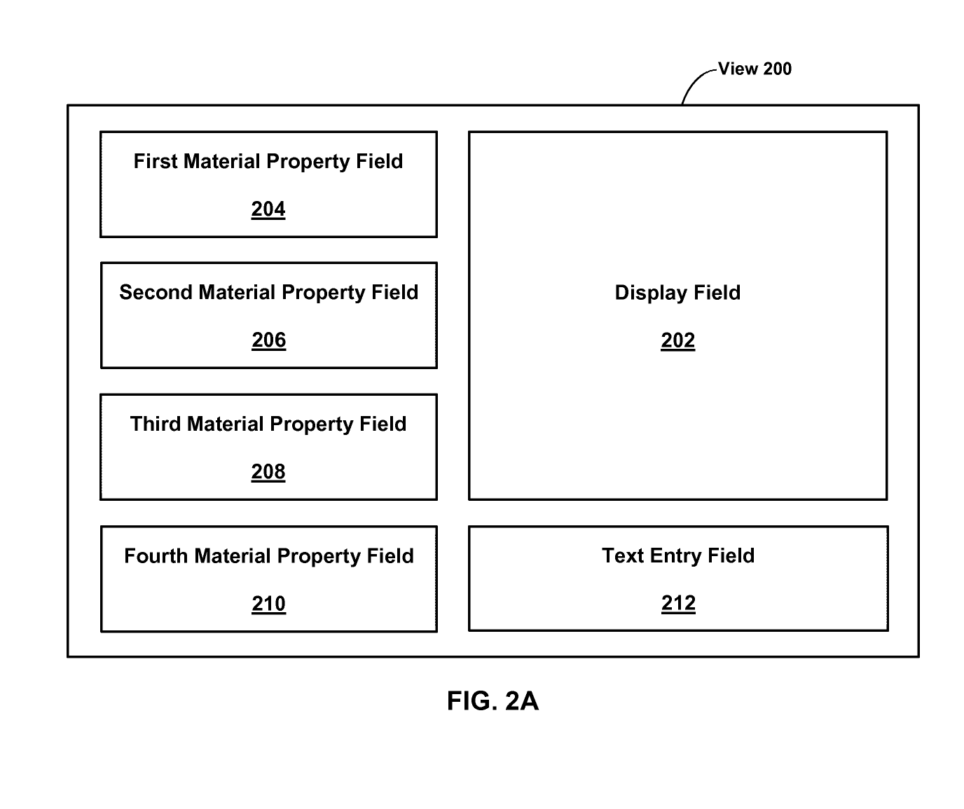

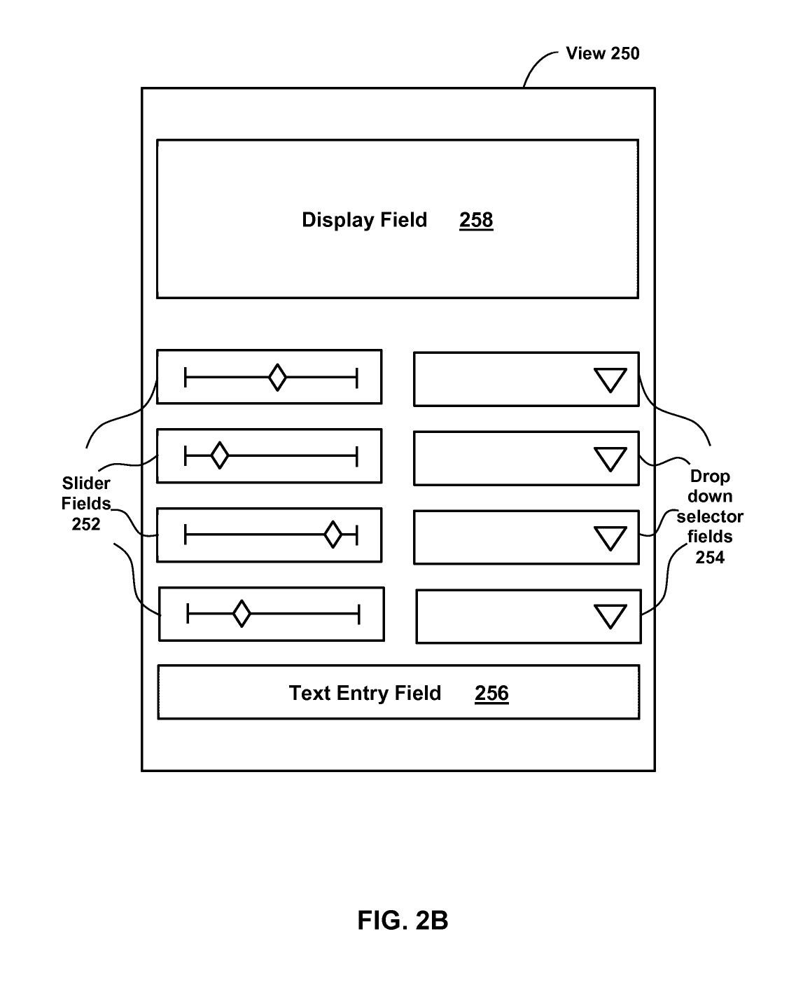

For example, FIG. 2A illustrates a view 200 of the graphical user interface presented to the user via user interface 30 (FIG. 1) that is configured to facilitate entry and/or selection of specified values for four different material properties. View 200 includes a display field configured to display the virtual model of the object to the user, first through fourth material property fields 204, 206, 208, and 210, and text entry field 212. Material property fields 204, 206, 208, and/or 210 are configured to facilitate entry and/or selection of specified values for four different material properties with fields 204, 206, 208, and/or 210 individually corresponding to different material properties. For example, first material property field 204 may correspond to hardness. Second material property field 206 may correspond to impact strength. Third material property field 208 may correspond to tensile strength. Fourth material property field 210 may correspond to a density of the object. The individual material property fields may be configured to receive entry and/or selection of specified values for the individual material properties. Text entry field 212 may be configured to receive entry of textual values for the individual material properties (in addition to and/or instead of fields 204, 206, 208, and 210), instructions for displaying and/or manipulating the virtual model of the object, a user's notes about material property selections, and/or other textual information. FIG. 2A is not intended to be limiting. The graphical user interface may include any number of views, any number of fields within the views, and/or any type of field that facilitates entry and/or selection of specified values for different material properties.

Returning to FIG. 1, in some implementations, material property component 24 may be configured such that the material properties have selectable ranges of values. For example, the material properties may include a first material property (e.g., hardness) having a first selectable range of values, and a second material property (e.g., impact strength) having a second selectable range of values. Material property component 24 may be configured to control user interface 30 to present one or more views of the graphical user interface that include one or more fields configured to facilitate entry and/or selection of values within the ranges of selectable values for the material properties. These fields may include slider fields, drop down selector fields, and/or other types of fields. In some implementations, for example, the fields may include a first slider field that corresponds to the first selectable range of values for the first material property, a second slider field that corresponds to the second selectable range of values for the second material property, a first drop down field that corresponds to a third selectable range of values for a third material property, a second drop down field that corresponds to a fourth selectable range of values for a fourth material property, etc.

By way of a non-limiting example, FIG. 2B illustrates a view 250 of the graphical user interface that includes one or more fields configured to facilitate entry and/or selection of values within the ranges of selectable values for the material properties. These fields may include slider fields 252, drop down selector fields 254, a text entry field 256, a display field 258, and/or other fields. Slider fields 252 and/or drop down selector fields 254 may individually correspond to different material properties. In some implementations, a drop down field may present one or more choices of material properties and, responsive to selection of one of the choices, a corresponding slider field may present the range of selectable values for that material property. In some implementations the selectable range of an individual slider field 252 and/or drop down choices for an individual drop down selector field 254 may be determined by material property component 24 based on a user's selection in one or more of the other slider fields 252 and/or drop down selector fields 254, based on material property information for physical real world materials (e.g., stored in a database that is part of external resources 40 described below), and/or other information. FIG. 2B is not intended to be limiting. The graphical user interface may include any number of views, any number of fields within the views, and/or any type of field that facilitates entry and/or selection of specified values for different material properties.

Returning to FIG. 1, in some implementations, the selectable ranges of values of the material properties may correspond to ranges of possible values for material properties of predetermined physical real world manufacturing materials used to manufacture the object. For example, the first selectable range of values (e.g., for hardness) may correspond to a first range of possible (e.g., hardness) values for one or more real world physical materials and the second selectable range of values may correspond to a second range of possible (e.g., impact strength) values for the one or more real world physical materials. In some implementations, material property component 24 may be configured to determine the second selectable range of values based on a user's entry and/or selection of a value for the first material property from the first selectable range of values. For example, responsive to a user selecting a value for hardness, system 10 may limit choices for impact strength to impact strength values for physical real world materials that have (and/or are capable of having) the hardness value specified by the user after manufacturing. In some implementations, material property component 24 may be configured to, responsive to receiving an indication from the user that a specified value for the second material property is outside the determined range of selectable values for the second material property, recommend changes to the value entered and/or selected by the user for the first material property. Continuing with the example above, responsive to a user entering an impact strength value that is outside a selectable range of impact strength values determined based on the previously specified hardness value, material property component 24 may recommend that the user adjust the specified value for hardness. Such determinations by material property component 24 may be made based, at least in part, on material property information stored in a material property database that is part of external resources 40, for example.

Model generation component 26 may be configured to generate an electronic three dimensional model of the object based on the obtained information (e.g., obtained by object component 22), the specified values for the one or more material properties (e.g., via material property component 24), information stored in electronic storage (e.g., simulation algorithms), information from external resources 40 (e.g., material property information from a material property database), and/or other information. In some implementations, model generation component 26 may be configured to cause user interface 30 to display the generated model via one or more views of the graphical user interface. The model may be displayed, for example, via a display 32 of user interface 30 and/or by other methods. Model generation component 26, user interface 30, and/or other components of system 10 may be configured such that the user may virtually manipulate the model via one or more control features provided by user interface 30. For example, a user may be able to rotate the model, shrink the model, enlarge the model, impart one or more forces on the model (e.g., virtually squeeze the model of the object), and/or manipulate the model in other ways.

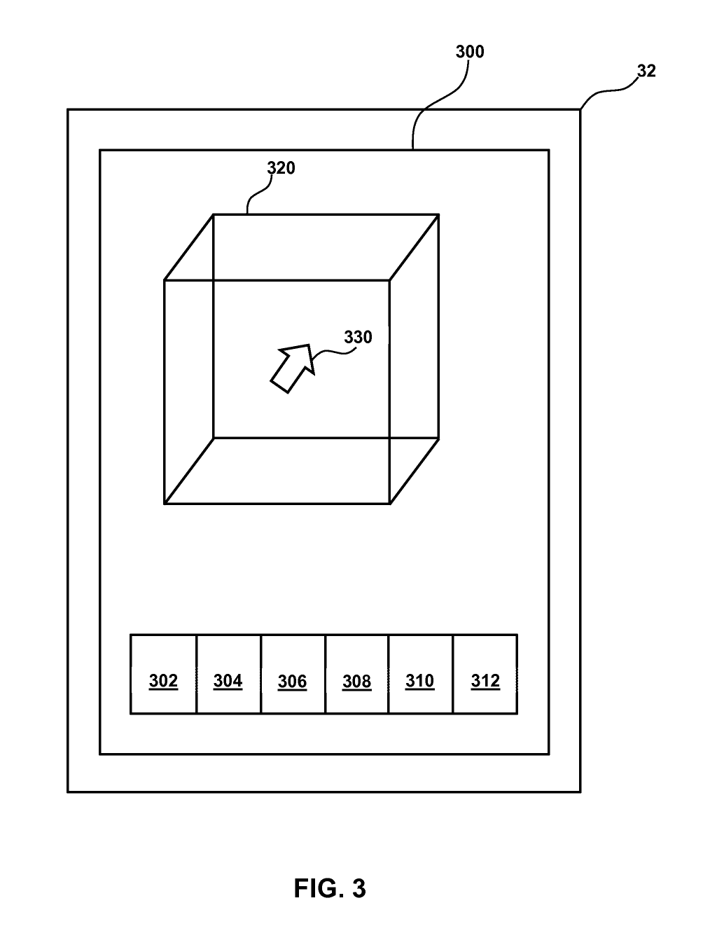

For example, FIG. 3 illustrates a view 300 of an electronic three dimensional model 320 generated by model generation component 26 (FIG. 1) presented to the user via display 32. View 300 includes manipulation control features 302, 304, 306, 308, 310, and 312. Using one or more of manipulation control features 302, 304, 306, 308, 310, and/or 312, a user may virtually manipulate model 320 (e.g., rotating, shrinking, enlarging, imparting one or more forces, etc.). In some implementations, a user may use a mouse to directly click 330 and/or drag on model 320 and/or use a keyboard to enter commands that directly manipulate model 320.

In some implementations, model generation component 26 (FIG. 1) may be configured to cause user interface 30 (FIG. 1) to present a result of a virtual manipulation of the model to a user (e.g., in view 300 of display 32). Characteristics of the virtual manipulation may be dictated by user entry and/or selection through user interface 30 (e.g., via manipulation control features 302, 304, 306, 308, 310, and/or 312) and/or other entry and/or selection by the user. The characteristics of the virtual manipulation of the model of the object may include one or more of an amount of force imparted on the object, an amount of movement experienced by the object, an amount the object is squeezed, a speed with which the object is bounced, a height from which the object is dropped, exposure to light, exposure to heat, and/or other characteristics. The presented result of the physical manipulation may include a simulated physical response of the model to the virtual manipulation that reflects the obtained information, the specified values of the one or more material properties, the characteristics of the virtual manipulation, and/or other information. The result of the physical manipulation presented to the user may be determined based on the obtained information (e.g., obtained by object component 22 shown in FIG. 1), the specified values for the one or more material properties (e.g., via material property component 24 shown in FIG. 1), information stored in electronic storage 50 (e.g., simulation algorithms), information from external resources 40 (e.g., material property information from a material property database), and/or other information.

In some implementations, system 10 (FIG. 1) may be configured such that, after a user views the result of the virtual manipulation, the user may go back and adjust his or her material property value specifications and system 10 may cause user interface 30 to present a result of a (the same and/or different) virtual manipulation of the adjusted model. This process may repeat any number of times until a user settles on an object having desired properties (as indicated by the result of the virtual manipulation presented to the user).

Returning to FIG. 1, physical material component 28 may be configured to determine an additive manufacturing material and/or material mixture that corresponds to the entered and/or selected values for the one or more material properties and/or facilitate purchase of the determined material and/or material mixture by the user. Physical material component 28 may determine the material(s) and/or facilitate purchase via external resources 40 and/or other resources. For example, physical material component 28 may determine the material(s) based on the material property information entered by the user, one or more material property databases (e.g., maintained by different manufacturers and/or material providers) included in external resources 40, and/or other information. After determining the materials, physical material component 28 may communicate material information, payment information, delivery information, and/or other information to a supplier via a communications network (e.g., the internet, a telephone communication network, etc.). In some implementations, physical material component 28 may be configured to communicate the material information and/or other information to an additive manufacturing device that is part of external resources 40 so that additive manufacturing device processing parameters and/or other information may be determined for the object to be manufactured. In some cases the material required may be synthesized from combinations of existing materials, chemically synthesized from other components in order to achieve final desired qualities, and/or formed in other ways.

User interface 30 may be configured to provide an interface between system 10 and a user through which the user may provide information to and receive information from system 10. This enables data, cues, results, and/or instructions and any other communicable items, collectively referred to as “information,” to be communicated between the user and system 10. By way of a non-limiting example, user interface 30 may be configured to receive entry and/or selection of material property information that specifies values for one or more material properties of the object to be manufactured. Receiving entry and/or selection of material property and/or other information may include a user typing information via a key pad and/or a keyboard, selecting (e.g., via a mouse and/or a touchscreen) information from a list of choices provided to the user, making a selection via slider icon displayed by user interface 30, uploading electronic information, and/or other entry and/or selection. In some implementations, user interface 30 and/or external resources 40 may be configured such that receiving entry and/or selection of information may include reading, scanning, and/or optically recognizing a physical object that identifies a user's desired object for additive manufacturing. For example, external resources 40 may include an optical sensor controlled via user interface 30 configured to scan a model of an object that is to be manufactured via additive manufacturing.

Examples of interface devices suitable for inclusion in user interface 30 include a touch screen, a keypad, touch sensitive and/or physical buttons, switches, a keyboard, knobs, levers, a display (e.g., display 32), speakers, a microphone, an indicator light, a printer, and/or other interface devices. In some implementations, user interface 30 includes a plurality of separate interfaces. In some implementations, user interface 30 includes at least one interface that is provided integrally with processor 20. In some implementations, user interface 30 may be included in a computing device (e.g., a desktop computer, a laptop computer, a tablet computer, a smartphone, etc.) associated with an individual user. In some implementations, user interface 30 may be included in a first computing device (e.g., a laptop computer) that is located remotely from a second computing device (e.g., a server) that includes processor 20.

It is to be understood that other communication techniques, either hard-wired or wireless, are also contemplated by the present disclosure as user interface 30. For example, the present disclosure contemplates that user interface 30 may be integrated with a removable storage interface provided by electronic storage 50. In this example, information may be loaded into system 10 from removable storage (e.g., a smart card, a flash drive, a removable disk) that enables the user to customize the implementation of system 10. Other exemplary input devices and techniques adapted for use with system 10 as user interface 30 include, but are not limited to, an RS-232 port, RF link, an IR link, modem (telephone, cable or other). In short, any technique for communicating information with system 10 is contemplated by the present disclosure as user interface 30.

External resources 40 may include sources of information (e.g., an electronic material property database, a manufacturing materials database), one or more servers outside of system 10, a network (e.g., the internet), electronic storage, data entry devices, sensors, scanners, computing devices associated with individual users, additive manufacturing devices, and/or other resources. In some implementations, some or all of the functionality attributed herein to external resources 40 may be provided by resources included in system 10. External resources 40 may be configured to communicate with processor 20 and/or other components of system 10 via wired and/or wireless connections, via a network (e.g., a local area network and/or the internet), via cellular technology, via Wi-Fi technology, and/or via other resources. For example, material property component 24 may access a material property database that is part of external resources 40 via the internet. As another example, external resources 40 may include an additive manufacturing device configured to produce objects by additive manufacturing. Such an additive manufacturing device may perform a layer by layer three dimensional object formation process wherein exposure to ultraviolet (UV) light cures (solidifies) a photopolymer resin and adheres the cured photopolymer resin to a previously solidified layer below. In some implementations, such an additive manufacturing device may be configured to communicate with processor 20, user interface 30, other external resources 40, electronic storage 50, and/or other components of system 10 wirelessly (e.g., via a wireless communication network such as the internet) and/or via wires. For example, the additive manufacturing device may include a transceiver and/or other communication components configured to facilitate wireless communication between the additive manufacturing device and other components of system 10 such that the additive manufacturing device may receive electronic information communicating a manufacturing material (and/or material mixture) modeled by the user via system 10 for fabrication of an object.

Electronic storage 50 may comprise electronic storage media that electronically stores information. The electronic storage media of electronic storage 50 may comprise one or both of system storage that is provided integrally (i.e., substantially non-removable) with system 10 and/or removable storage that is removably connectable to system 10 via, for example, a port (e.g., a USB port, a firewire port, etc.) or a drive (e.g., a disk drive, etc.). Electronic storage 50 may comprise one or more of optically readable storage media (e.g., optical disks, etc.), magnetically readable storage media (e.g., magnetic tape, magnetic hard drive, floppy drive, etc.), electrical charge-based storage media (e.g., EPROM, RAM, etc.), solid-state storage media (e.g., flash drive, etc.), and/or other electronically readable storage media. Electronic storage 50 may store software algorithms (e.g., object simulation algorithms), information (e.g., material property values) obtained, received, and/or determined by processor 20, and/or other information that enables system 10 to function as described herein. Electronic storage 50 may be (in whole or in part) a separate component within system 10, or electronic storage 50 may be provided (in whole or in part) integrally with one or more other components of system 10 (e.g., processor 20).

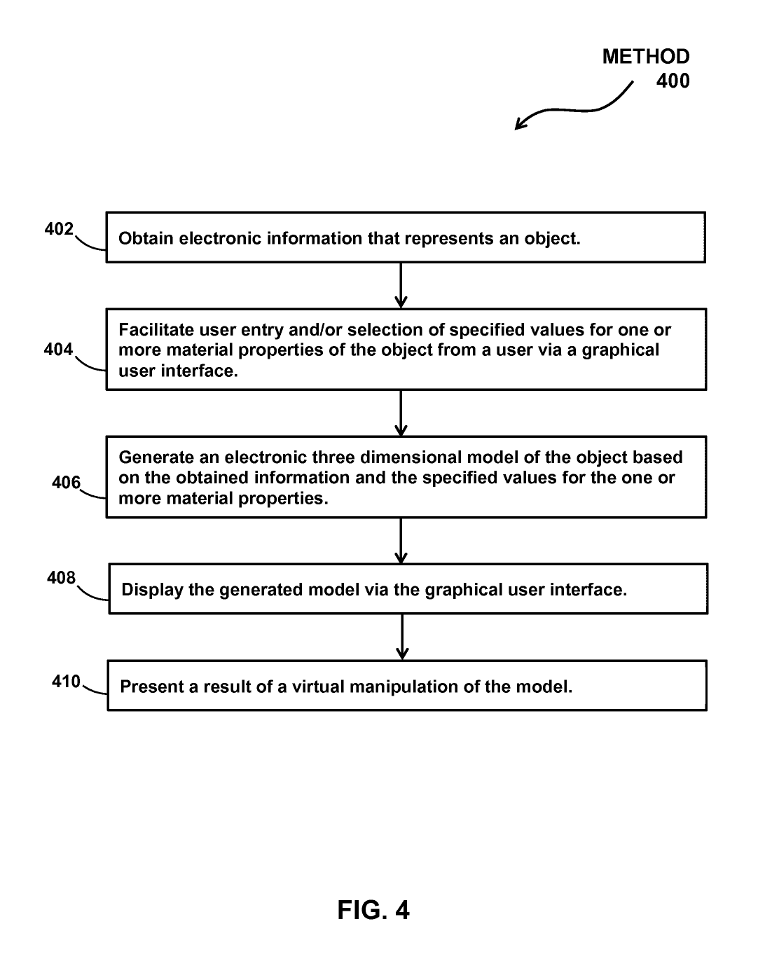

FIG. 4 illustrates a method 400 for facilitating material selection for a physical three dimensional object to be manufactured by additive manufacturing. The selection may be facilitated via a graphical user interface, for example. The operations of method 400 presented below are intended to be illustrative. In some implementations, method 400 may be accomplished with one or more additional operations not described, and/or without one or more of the operations discussed. Additionally, the order in which the operations of method 400 are respectively illustrated in FIG. 4 and described below is not intended to be limiting.

In some implementations, method 400 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 400 in response to instructions stored electronically on an electronic storage medium. The one or more processing devices may include one or more devices configured through hardware, firmware, and/or software to be specifically designed for execution of one or more of the operations of method 400.

At an operation 402, electronic information that represents the object may be obtained. In some implementations, the obtained electronic information that represents the object may include dimensions of the object and/or other information. Operation 402 may be performed by a computer processor component that is the same as or similar to object component 22 (shown in FIG. 1 and described herein).

At an operation 404, user entry and/or selection of specified values for one or more material properties of the object may be facilitated. The user entry and/or selection may be facilitated via a graphical user interface, for example. In some implementations, the one or more material properties may include one or more of elastic modulus, hardness, density, weight, color, refractive index, dielectric properties, tensile strength, glass transition temperature, impact strength, and/or other properties. In some implementations, the one or more material properties may include a first material property having a first selectable range of values and a second material property having a second selectable range of values, for example. In some implementations, the graphical user interface may comprise one or more views that include one or more fields configured to facilitate entry and/or selection of the values of the material properties. In some implementations, the fields may include a first slider field that corresponds to the first selectable range of values and a second slider field that corresponds to the second selectable range of values. In some implementations, the first selectable range of values and the second selectable range of values correspond to a range of possible material properties of predetermined manufacturing materials used to manufacture the object. In some implementations, the second selectable range of values is determined based on a user's entry and/or selection of a value for the first material property from the first selectable range of values. In some implementations, responsive to receiving an indication from the user that a specified value for the second material property is outside the determined range of selectable values for the second material property, operation 404 may include recommending changes to the value entered and/or selected by the user for the first material property. Operation 404 may be performed by a computer processor component that is the same as or similar to material property component 24 (shown in FIG. 1 and described herein).

At an operation 406, an electronic three dimensional model of the object may be generated based on the obtained information, the specified values for the one or more material properties, and/or other information. Operation 406 may be performed by a computer processor component that is the same as or similar to model generation component 26 (shown in FIG. 1 and described herein).

At an operation 408, the generated model may be displayed. The generated model may be displayed via the graphical user interface, for example. Operation 408 may be performed by a computer processor component that is the same as or similar to model generation component 26 (shown in FIG. 1 and described herein).

At an operation 410, a result of a virtual manipulation of the model may be presented. A characteristic of the virtual manipulation may be dictated by user entry and/or selection through the graphical user interface. The result may include a simulated physical response of the model to the virtual manipulation that reflects the obtained information and the specified values of the one or more material properties, for example. The characteristic of the virtual manipulation of the model of the object may include one or more of an amount of force imparted on the object, an amount of movement experienced by the object, an amount the object is squeezed, a speed with which the object is bounced, a height from which the object is dropped, and/or other characteristics. Operation 410 may be performed by a computer processor component that is the same as or similar to model generation component 26 (shown in FIG. 1 and described herein).

In some implementations, operation 410 includes determining an additive manufacturing material that corresponds to the entered and/or selected values for the one or more material properties and facilitating purchase of the determined material by the user (e.g., performed by physical material component 28).

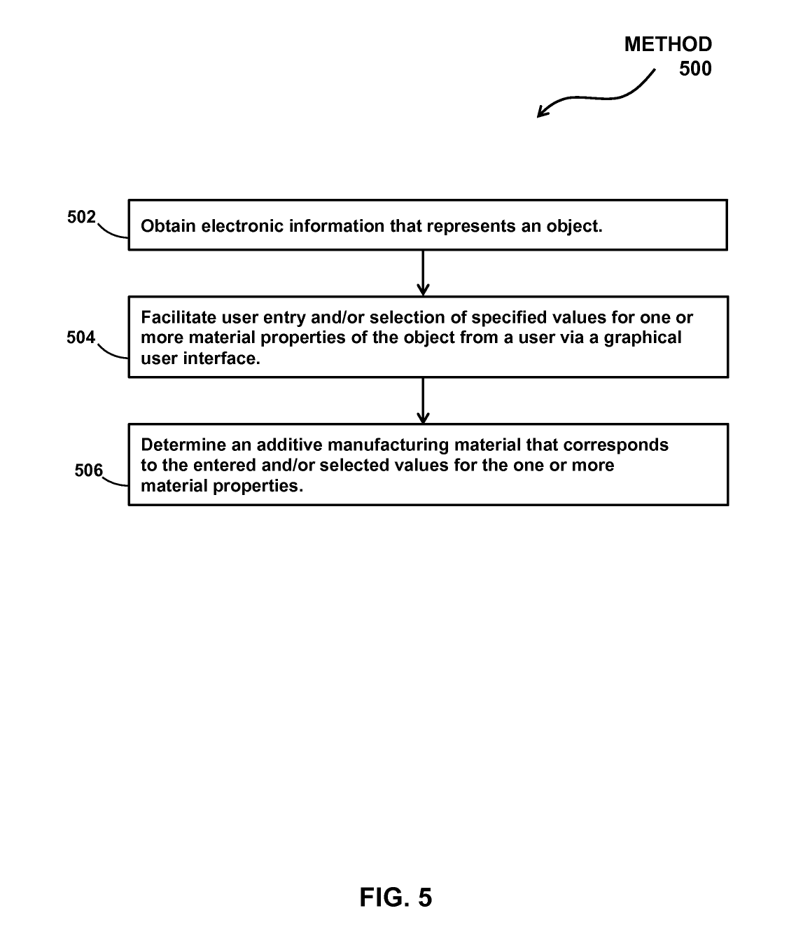

FIG. 5 illustrates a method 500 for facilitating material selection for a physical three dimensional object to be manufactured by additive manufacturing. The selection may be facilitated via a graphical user interface, for example. The operations of method 500 presented below are intended to be illustrative. In some implementations, method 500 may be accomplished with one or more additional operations not described, and/or without one or more of the operations discussed. Additionally, the order in which the operations of method 500 are respectively illustrated in FIG. 5 and described below is not intended to be limiting.

In some implementations, method 500 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 500 in response to instructions stored electronically on an electronic storage medium. The one or more processing devices may include one or more devices configured through hardware, firmware, and/or software to be specifically designed for execution of one or more of the operations of method 500.

At an operation 502, electronic information that represents the object may be obtained. In some implementations, the obtained electronic information that represents the object may include dimensions of the object and/or other information. Operation 502 may be performed by a computer processor component that is the same as or similar to object component 22 (shown in FIG. 1 and described herein).

At an operation 504, user entry and/or selection of specified values for one or more material properties of the object may be facilitated. The user entry and/or selection may be facilitated via a graphical user interface, for example. In some implementations, the one or more material properties may include one or more of elastic modulus, hardness, density, weight, color, refractive index, dielectric properties, tensile strength, glass transition temperature, impact strength, and/or other properties. In some implementations, the one or more material properties may include a first material property having a first selectable range of values and a second material property having a second selectable range of values, for example. In some implementations, the graphical user interface may comprise one or more views that include one or more fields configured to facilitate entry and/or selection of the values of the material properties. In some implementations, the fields may include a first slider field that corresponds to the first selectable range of values and a second slider field that corresponds to the second selectable range of values. In some implementations, the first selectable range of values and the second selectable range of values correspond to a range of possible material properties of predetermined manufacturing materials used to manufacture the object. In some implementations, the second selectable range of values is determined based on a user's entry and/or selection of a value for the first material property from the first selectable range of values. In some implementations, responsive to receiving an indication from the user that a specified value for the second material property is outside the determined range of selectable values for the second material property, operation 504 may include recommending changes to the value entered and/or selected by the user for the first material property. Operation 504 may be performed by a computer processor component that is the same as or similar to material property component 24 (shown in FIG. 1 and described herein).

At an operation 506, an additive manufacturing material that corresponds to the entered and/or selected values for the one or more material properties may be determined. In some implementations, operation 506 may include facilitating purchase of the determined material by the user. Operation 506 may be performed by a computer processor component that is the same as or similar to physical material component 28 (shown in FIG. 1 and described herein).

Returning to FIG. 1, processor 20 may be configured to provide information processing capabilities in system 10. As such, processor 20 may comprise one or more of a digital processor, an analog processor, a digital circuit designed to process information, an analog circuit designed to process information, a state machine, and/or other mechanisms for electronically processing information. Although processor 20 is shown in FIG. 1 as a single entity, this is for illustrative purposes only. In some implementations, processor 20 may comprise a plurality of processing units. These processing units may be physically located within the same device (e.g., a server, a desktop computer, a laptop computer, a tablet computer, a smartphone, and/or other computing devices, within an additive manufacturing device (external resources 40), etc.), or processor 20 may represent processing functionality of a plurality of devices operating in coordination (e.g., a server, a remotely located computer, and an additive manufacturing device). Processor 20 may be configured to execute components 22, 24, 26, and/or 28 by software; hardware; firmware; some combination of software, hardware, and/or firmware; and/or other mechanisms for configuring processing capabilities on processor 20.

It should be appreciated that although components 22, 24, 26, and 28 are illustrated in FIG. 1 as being co-located within a single processing unit. In implementations in which processor 20 comprises multiple processing units, one or more of components 22, 24, 26, and/or 28 may be located remotely from the other components (e.g., such as within an additive manufacturing device). The description of the functionality provided by the different components 22, 24, 26, and/or 28 described herein is for illustrative purposes, and is not intended to be limiting, as any of components 22, 24, 26, and/or 28 may provide more or less functionality than is described. For example, one or more of components 22, 24, 26, and/or 28 may be eliminated, and some or all of its functionality may be provided by other components 22, 24, 26, and/or 28. As another example, processor 20 may be configured to execute one or more additional components that may perform some or all of the functionality attributed below to one of components 22, 24, 26, and/or 28. In some implementations, one or more of components 22, 24, 26, and/or 28 may be executed by a processor incorporated in user interface 30, external resources 40, electronic storage 50, a remotely located server, and/or other components of system 10.

Although the system(s) and/or method(s) of this disclosure have been described in detail for the purpose of illustration based on what is currently considered to be the most practical and preferred implementations, it is to be understood that such detail is solely for that purpose and that the disclosure is not limited to the disclosed implementations, but, on the contrary, is intended to cover modifications and equivalent arrangements that are within the spirit and scope of the appended claims. For example, it is to be understood that the present disclosure contemplates that, to the extent possible, one or more features of any implementation can be combined with one or more features of any other implementation.

What is claimed is:

1. A system configured to facilitate material selection for a physical three dimensional object to be manufactured by additive manufacturing, the selection being facilitated via a graphical user interface, the system comprising:
one or more physical computer processors configured by computer readable instructions to:
obtain electronic information that represents the object;
facilitate user entry and/or selection of specified values for one or more material properties of the object from a user via the graphical user interface;
generate an electronic three dimensional model of the object based on the obtained information and the specified values for the one or more material properties;
display the generated model via the graphical user interface; and
present a result of a virtual manipulation of the model, a characteristic of the virtual manipulation being dictated by user entry and/or selection through the graphical user interface, the result including a simulated physical response of the model to the virtual manipulation that reflects the obtained information and the specified values of the one or more material properties.

2. The system of claim 1, wherein the one or more physical computer processors are configured such that the characteristic of the virtual manipulation of the model of the object includes one or more of an amount of force imparted on the object, an amount of movement experienced by the object, an amount the object is squeezed, a speed with which the object is bounced, or a height from which the object is dropped.

3. The system of claim 1, wherein the one or more physical computer processors are configured such that the one or more material properties include one or more of elastic modulus, hardness, density, weight, color, refractive index, dielectric properties, tensile strength, glass transition temperature, or impact strength.

4. The system of claim 1, wherein the one or more physical computer processors are configured such that the obtained electronic information that represents the object includes dimensions of the object.

5. The system of claim 1, wherein the one or more physical computer processors are configured such that the one or more material properties include a first material property having a first selectable range of values and a second material property having a second selectable range of values.

6. The system of claim 5, wherein the one or more physical computer processors are configured such that the graphical user interface comprises one or more views that include one or more fields configured to facilitate entry and/or selection of the values of the material properties, and wherein the fields include a first slider field that corresponds to the first selectable range of values and a second slider field that corresponds to the second selectable range of values.

7. The system of claim 5, wherein the one or more physical computer processors are configured such that the first selectable range of values and the second selectable range of values correspond to a range of possible material properties of predetermined manufacturing materials used to manufacture the object.

8. The system of claim 5, wherein the one or more physical computer processors are configured to determine the second selectable range of values based on a user's entry and/or selection of a value for the first material property from the first selectable range of values.

9. The system of claim 8, wherein the one or more physical computer processors are configured to, responsive to receiving an indication from the user that a specified value for the second material property is outside the determined range of selectable values for the second material property, recommend changes to the value entered and/or selected by the user for the first material property.

10. The system of claim 1, wherein the one or more physical computer processors are further configured to determine an additive manufacturing material that corresponds to the entered and/or selected values for the one or more material properties and facilitate purchase of the determined material by the user.

11. A system configured to facilitate material selection for a physical three dimensional object to be manufactured by additive manufacturing, the selection being facilitated via a graphical user interface, the system comprising:
one or more physical computer processors configured by computer readable instructions to:
obtain electronic information that represents the object;
facilitate user entry and/or selection of specified values for one or more material properties of the object from a user via the graphical user interface; and
determine an additive manufacturing material that corresponds to the entered and/or selected values for the one or more material properties.

12. The system of claim 11, wherein the one or more physical computer processors are further configured to facilitate purchase of the determined material by the user.

13. The system of claim 11, wherein the one or more physical computer processors are configured such that the one or more material properties include one or more of elastic modulus, hardness, density, weight, color, refractive index, dielectric properties, tensile strength, glass transition temperature, or impact strength.

14. The system of claim 11, wherein the one or more physical computer processors are configured such that the obtained electronic information that represents the object includes dimensions of the object.

15. The system of claim 11, wherein the one or more physical computer processors are configured such that the one or more material properties include a first material property having a first selectable range of values and a second material property having a second selectable range of values.

16. The system of claim 15, wherein the one or more physical computer processors are configured such that the graphical user interface comprises one or more views that include one or more fields configured to facilitate entry and/or selection of the values of the material properties, and wherein the fields include a first slider field that corresponds to the first selectable range of values and a second slider field that corresponds to the second selectable range of values.

17. The system of claim 15, wherein the one or more physical computer processors are configured such that the first selectable range of values and the second selectable range of values correspond to a range of possible material properties of predetermined manufacturing materials used to manufacture the object.

18. The system of claim 15, wherein the one or more physical computer processors are configured to determine the second selectable range of values based on a user's entry and/or selection of a value for the first material property from the first selectable range of values.

19. The system of claim 18, wherein the one or more physical computer processors are configured to, responsive to receiving an indication from the user that a specified value for the second material property is outside the determined range of selectable values for the second material property, recommend changes to the value entered and/or selected by the user for the first material property.

20. The system of claim 11, wherein the one or more physical computer processors are further configured to:
generate an electronic three dimensional model of the object based on the obtained information and the specified values for the one or more material properties;
display the generated model via the graphical user interface; and
present a result of a virtual manipulation of the model, a characteristic of the virtual manipulation being dictated by user entry and/or selection through the graphical user interface, the result including a simulated physical response of the model to the virtual manipulation that reflects the obtained information and the specified values of the one or more material properties.

21. The system of claim 20, wherein the one or more physical computer processors are configured such that the characteristic of the virtual manipulation of the model of the object includes one or more of an amount of force imparted on the object, an amount of movement experienced by the object, an amount the object is squeezed, a speed with which the object is bounced, or a height from which the object is dropped.
